(19) United States
(12) Patent Application Publication
(10) Pub. No.: US 2009/0019474 A1
(43) Pub. Date: Jan. 15, 2009

(54) Alternative mechanism to associate supplemental/advertising information with multimedia programs

(76) Inventor: Robert Robotham, Ottawa (CA)

Correspondence Address: ALCATEL-LUCENT, C/O GALASSO & ASSOCIATES, LP, P. O. BOX 26503, AUSTIN, TX, 78755-0503, US

(21) Appl. No.: 12/215,807

(22) Filed: Jun. 30, 2008

Related U.S. Application Data
(63) Continuation-in-part of application No. 11/503,284, filed on Aug. 14, 2006.

(51) Int. Cl. H04N 7/025; H04N 7/16

(52) U.S. Cl. 725/35; 725/132

(57) ABSTRACT

The invention involves an interactive system and method for selection and display of advertisements, product information and other information in programming that can be updated at any time by advertisers and accessed at any time by television viewers without requiring any more functionality from the user terminal than is currently required for interactive services. The invention preferably utilizes insertion of a large number of interactivity points into video programs associated with certain times or frames of a program that can be compared to supplemental information locations in a program to obtain supplemental information links.

### CROSS REFERENCE TO RELATED APPLICATIONS

This United States Non-Provisional Patent application is a continuation-in-part of U.S. patent application Ser. No. 11/503,284 entitled “Approach for Associating Advertising Supplemental Information with Video Programming” filed on Aug. 14, 2006.

### FIELD OF THE DISCLOSURE

The disclosures made herein relate generally to the communication network industry. The invention discussed herein is in the general classification of association of supplemental information with video programming.

### BACKGROUND

Television commercials are one of the most popular types of advertisement for goods and services and promotion of charitable or political causes. A service provider usually charges product and service promoters for these commercials at varying rates depending on time slots and other considerations.

Some television commercials are annoying, bothersome or not relevant to a given television viewer. These commercials are usually ignored by the television viewer as he awaits a return to the scheduled programming. Alternatively, a television viewer may change the channel while commercials are displayed on one channel, causing such commercials to be wholly ineffective for that television viewer.

Many television viewers also choose to use a device that records programming and allows for fast forwarding through commercials. Again, the use of this device diminishes the effectiveness of commercials.

Regular commercial advertising on television also is subject to strict time constraints, preventing an advertiser from presenting all of the relevant and necessary information that a television viewer/consumer would desire before purchasing goods or services.

Shopping channels provide an alternative means for advertising products and services, but these networks are tedious to watch and usually have limited viewership.

Many advertisers have turned to product placement within a television program or movie to promote their products. However, product placement only works well for products that are easily identifiable and well known already by consumers. The amount of information related to a product used in a television program or movie is also quite limited.

Advertisers have also used billboards in arenas or other entertainment venues to promote certain products. Recently, superimposing advertisements on fields, courts or the like has been used to promote certain products and services. However, the efficacy of this type of advertising also suffers from the limited amount of time available for display and limited information conveyed in such an advertisement.

To provide a type of advertising without many of the drawbacks of traditional television advertising, an innovative method of associating supplemental information with a video program is needed that enables the association of information with virtually everything in a program. There can be many objects within a program for which supplemental information needs to be available simultaneously. Also, a capability for adding information at any time for the given product and accessing information at any time by the television viewer are necessary.

GET Interactive has an advertising model that currently addresses the need for providing links to items shown on the screen of a program. It is available for internet distributed video and video over mobile phones and is expected to become available for IPTV. When interactivity is triggered, the viewer is presented with a series of still images taken from the program. The viewer selects a still image which has a number of icons superimposed indicating the items that may be accessed.

The GET Interactive solution has limits on the number of items that can be active within a given frame. It also requires a pointer interface (e.g. a mouse or trackpad) and requires the viewer to find the appropriate frame, which for a long program becomes a significant issue.

United States Patent Application No. 2008/0040768 A1, having the same named inventor as the current application, provides more functionality and allows frame accurate selection of frames containing the object of interest to the viewer. The disclosures of United States Patent Application No. 2008/0040768 are incorporated herein by reference.

United States Patent Application No. 2008/0040768 allows information to be associated with a time (or rather a range of frames) of a program and the user terminal can access this information by signaling a server with the frame identifier. While a number of mechanisms have been recognized to allow the determination of the frame identifier by the user terminal, the fact remains that this is not currently standard functionality in all consumer video equipment, and as such would need to be added to the equipment.

Existing interactive services, however, permit insertion of interactivity points into the video transport stream before a program is distributed to viewers (i.e. broadcast). Changes or additions to interactivity points require changes to the transport stream and program rebroadcast.

Hence, there is a need in the art for a convenient to use, reliable, and inexpensive interactive system and method for selection and display of advertisements and product information in programming that can be updated at any time by advertisers and accessed at any time by television viewers without requiring any more functionality from the user terminal than is already required for interactive services.

### SUMMARY OF THE DISCLOSURE

The current invention is a method and system for selection and display of advertisements and product information in programming that can be updated at any time by advertisers and accessed at any time by television viewers without requiring any more functionality from the user terminal than is already required for interactive services.

The invention involves insertion of a large number of interactivity points into video programs which will open a session and search for information associated with the set of frames associated with the interactivity point. More interactivity points will increase the level of precision that can be achieved.

One interactivity point per scene is the minimum resolution desired, although fewer are not precluded by this invention. There are several software tools existing that can automatically partition a video into scenes. An alternative approach could be to simply insert the interactivity points as frequently as possible, taking into account the limitations of the user terminals and the bandwidth consumed. In cases in which scenes change more rapidly than what the system can support, scenes may need to be aggregated in an intelligent manner.

The interactivity points will provide the viewer with a menu based interface to retrieve information/initiate e-commerce activities on objects shown in the program. The preferred solution will provide a hierarchical classification system to allow the viewer to quickly find the item(s) they are interested in, or to store a reference to the interactivity access point for later access (e.g. after the end of the program) or to register interest in something that does not currently have any associated information.

While the supplemental information is accessed through the interactivity points, the identification of which supplemental information is associated with these interactivity points is preferably based on a master set of associations based on program frame number/time, as in the previously filed patent. A function to determine what items are valid at any point in time within the range represented by a given interactivity point is straight forward. A given interactivity point will be active for a known period of the program; objects in the program with associated supplemental information will be present on screen at known period(s) (times or frames) of the program. Any supplemental information related to any object relevant for any part of the time that the interactivity point is active will be accessible throughout that interactivity point.

This function may execute whenever a viewer accesses an interactivity point. Alternatively, the function may execute when the interactivity point locations are set for distribution of a program and when items are added to the master set of associations or the set of associations is otherwise updated.

This allows the relationship between a program and supplemental information to be input and stored independently of the video distribution mechanism used. Different video distribution methods may have different limitations on the location of interactivity points. If the supplemental information were to be associated directly with interactivity points, then different video distributions with different interactivity points would require the associations to be regenerated for the different versions.

The principal object of this invention is to provide a system and method for selection and display of advertisements, product information and other information in programming that can be updated at any time by advertisers and accessed at any time by television viewers.

Another object of this invention is to provide a system and method for selection and display of advertisements, product information and other information in programming that can be updated at any time by advertisers and accessed at any time by television viewers without requiring any more functionality from the user terminal than is already required for interactive services.

Another object of this invention is to provide a system and method for selection and display of advertisements, product information and other information in programming that contains extensive information related to the advertisement, product or the programming itself.

Another object of this invention is to provide a system and method for selection and display of advertisements and product information in programming that can be utilized for both known and unknown products and services.

Another object of this invention is to provide a system and method for selection and display of advertisements and product information in programming that can be updated at any time by advertisers and accessed at any time by television viewers that is relatively inexpensive to implement and maintain.

Another object of this invention is to provide a reliable system and method for selection and display of advertisements and product information in programming that can be updated at any time by advertisers and accessed at any time by television viewers.

Yet another object of this invention is to provide a convenient to use system and method for selection and display of advertisements and product information in programming that can be updated at any time by advertisers and accessed at any time by television viewers.

### BRIEF DESCRIPTION OF THE DRAWINGS

FIG. 1 depicts a diagram of a system according to the preferred embodiment of the invention.

FIG. 2 depicts a diagram of an embodiment of the query processor; and

FIG. 3 depicts an example of how the supplemental information for a commercial is correlated with the program and with a consumer query.

### DETAILED DESCRIPTION OF THE DRAWINGS

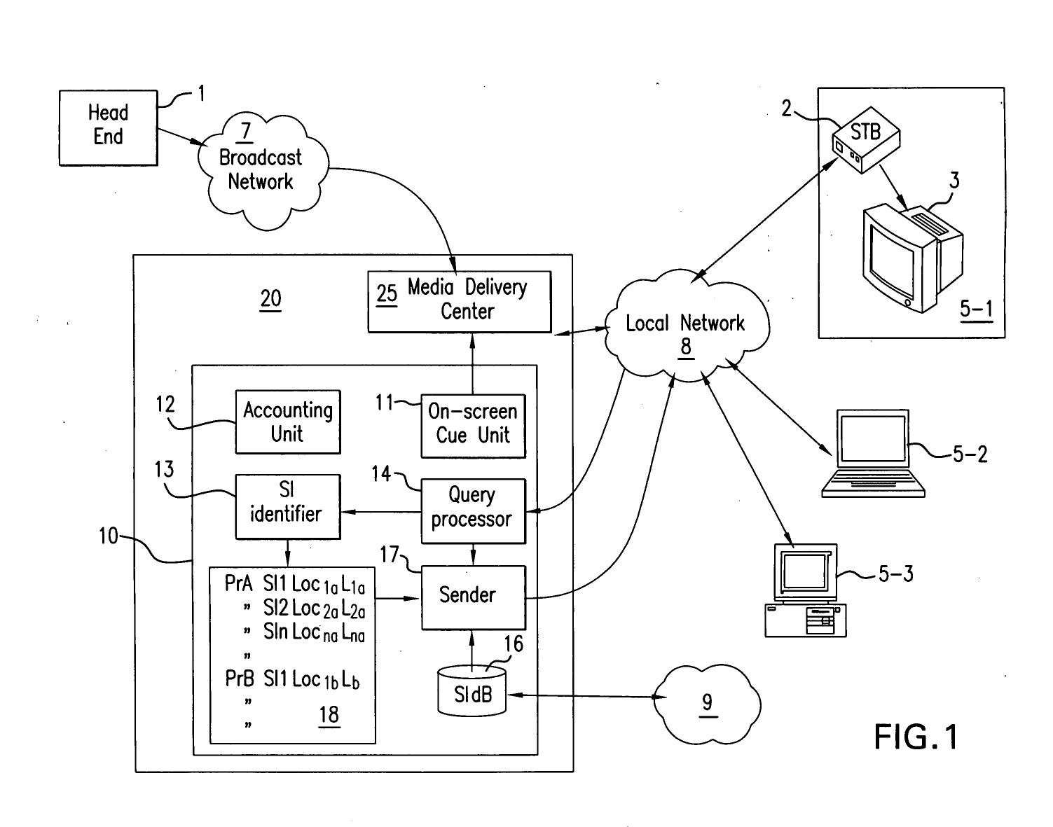

FIG. 1 depicts a diagram of a system according to the preferred embodiment of the invention. Interactivity points are inserted at broadcast network 7 prior to broadcast. Programming is provided from a head-end 1 to a local server 20 over the broadcast network 7. Local server 20 is equipped with a media delivery center 25 that performs the well known functionality of such a center for delivering video content to subscribers/consumers over a local network 8.

FIG. 1 also shows three consumer terminals 5-1, 5-2, and 5-3. 5-1 is a set-top box (STB) 2 and a television set 3. Terminal 5-2 is a laptop and terminal 5-3 is a personal computer. Terminals 5-1, 5-2 and 5-3 enable trick-play (pause, rewind, fast forward, etc. of the programming). Trick-play allows a user to record the program and research an ad associated with it immediately or to record parts of interest of the program for researching the embedded commercials later or to bookmark points in the program to allow access of associated supplemental information about advertisements at a later time.

A supplemental information (SI) unit 10 is provided at the local server 20 for enabling the users in a geographical area served by local server 20 to access the available supplemental information of interest. SI unit 10 provides access to the supplemental information to terminals 5-1, 5-2 and 5-3 upon request.

After programming is developed, the supplemental information is associated with particular interactivity points in the programming that direct the consumer to sources of information. A SI location refers to the section (time frame) within a given program during which a given supplemental information link is relevant.

The SI unit 10 includes an SI database 16 that stores the supplemental information, a table 18 that provides the association between the SI locations and the supplemental information links to the respective supplemental information. Table 18 shows the SI locations for a program A denoted with PrA with n different instances where supplemental information is available. The first supplemental information SI₁ is available at a location denoted with Loc₁ (the temporal location within the program measured in any of a variety of ways including time elapsed and time remaining in the program). Loc₁ can be associated with a certain interactivity point inserted into the programming prior to broadcasting.

In order to research a product or service, a consumer clicks while a subject of interest is being presented in the program, using a channel selector or the mouse. The click generates a query that arrives at a query processor 14 in the SI unit 10. The consumer terminal 5-1, 5-2 or 5-3 or the SI unit 10 or both determine the most recently viewed interactivity point of the program.

FIG. 1 shows an embodiment where the query-processor 14 determines the program being viewed, the location of the query within the program (interactivity point) and identifies the consumer terminal (5-1, 5-2 or 5-3) that generated the query. The program interactivity point of the query is used to identify entries in the table 18 as directed by SI identifier unit 13. The SI identifier unit 13 receives the interactivity point and associates it with a certain time frame (e.g. thirty seconds to sixty second into the program) in the program. All entries in the table 18 for supplemental information located within that time frame will have supplemental information links sent to the appropriate consumer terminal.

A sender 17 is used to provide the link information to the consumers. Sender 17 is also used to deliver to the consumer terminal (5-1, 5-2, 5-3) data requested from the SI database 16 which may include additional links that direct the consumer to more detailed information. This is shown via a network 9 that may be the internet with a large amount of information or a private network with less information.

The SI unit 10 may also be equipped with an accounting unit 12 to monitor use of commercials for establishing a revenue value for each program according to the usage of the supplemental information.

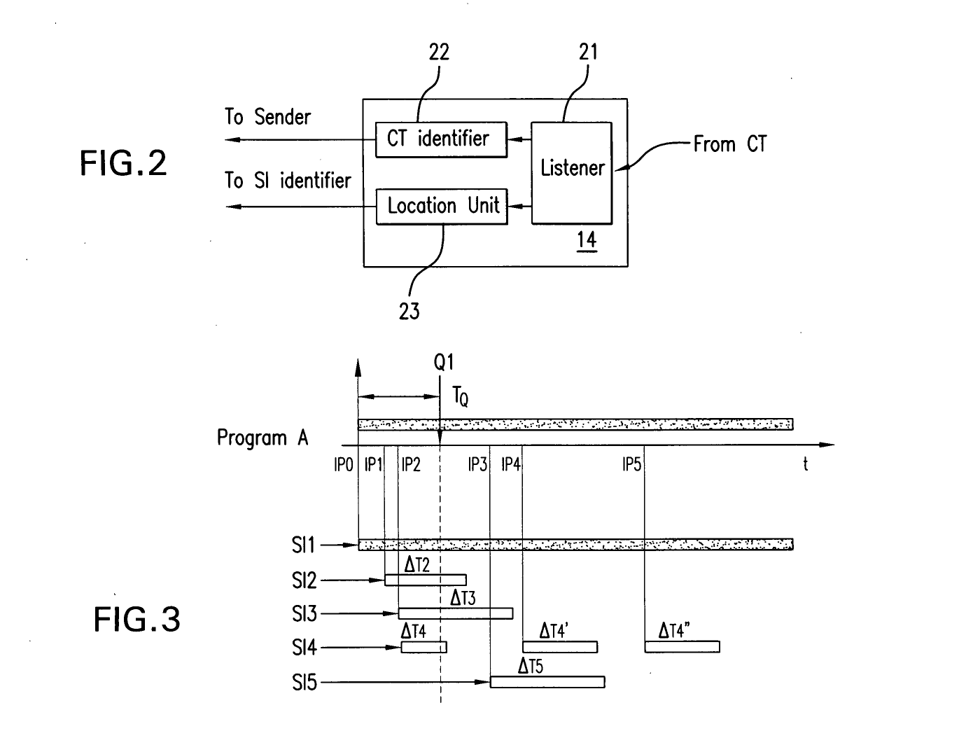

FIG. 2 depicts a diagram of an embodiment of the query processor. The query processor 14 includes a listener 21 for detecting all queries generated by the consumer terminals, a consumer terminal identifier 22 that associates the query with a specific terminal and a location unit 23. The location unit 23 identifies the associated program and a specific location (interactivity point) in said program of the respective query which is provided to the SI identifier unit to determine the correct entries in the table of the SI unit. Information on program playback from the Media Delivery Center 25 may include information required to translate the interactivity point to the format used in the table.

It is also possible to configure the consumer terminal to provide on screen cues when supplemental information is available. In FIG. 1, an on-screen cue unit 11 is used for inserting cues indicating to the consumer that the respective view enables obtaining of supplemental information.

FIG. 3 depicts an example of how the supplemental information for a commercial is correlated with the program and with a consumer query. Supplemental information SI₁ is associated with the entire program A from IP₀ (interactivity point 0) to the end of the program (all interaction points). For example, if the program is a movie, the link L₁ associated with SI₁ directs the consumers to general information about the movie whenever he clicks on any scene during playback.

SI₂ provides information about some cars, for example, and the SI location identifies a sequence extending from IP₁ for a relevant time of ΔT2. ΔT2 extends from IP₁ into a portion of IP₂. Any click during the range of time associated with IP₁ or IP₂ will cause the link L₂ leading to the actual SI₂ to appear for the consumer even when the ΔT2 period has past. In other words, the period of time of relevancy for a particular link to supplemental information may overlap with only a portion of the period of time associated with a given interactivity point. This causes the link to be accessible even before it becomes relevant or after it has ceased being relevant. This is also why having interactivity points spaced closely together is preferable.

ΔT3 starts at IP₂ and continues into IP₃ and may provide a link L₃ to information about, for example, a certain museum shown in that sequence (SI₃). Any click during the period of time associated with IP₂ or IP₃ will cause the link L₃ leading to SI₃ to appear for the consumer.

In SI₄, the supplemental information is relevant at three instances, ΔT4, ΔT4′ and ΔT4″ during the course of program A. These time periods are during a portion of the period of time associated with IP₂, IP₄ and IP₅. The appropriate link L₄ to SI₄ would be sent to a consumer terminal whenever a click occurs during the time period of a program associated with IP₂, IP₄ and IP₅.

These links are sent to the consumer terminal that issued the query using the sender. The link(s) of interest may be stored, and the program may be resumed. Alternatively, the viewing of the program may be suspended while the consumer follows the link or the location of the program of the query may be stored and the program resumed.

When a user terminal initiates a session of interactivity, a page is generated providing a menu to the viewer to allow the selection of supplemental information links that are of interest to them after they are returned to them from the SI unit. This menu is derived from the database considering the period of the program the interactivity point is associated with and uses the categorization of the subjects that are valid during that period to structure the menu. The page may be saved (associated with the viewer identification) at any time for later access. The functionality that may be associated with a given subject is open ended, and may include supplemental information in any form of text, audio or video, opportunities for e-commerce, contact with manufacturers/vendors, etc.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A system for associating supplemental information from a local server with a program distributed to consumer terminals, comprising at said local server:
(a) a table for maintaining an association between a supplemental information link and a supplemental information location within said program where the supplemental information link is relevant;
(b) a query processor for receiving a query from a consumer terminal and determining an interactivity point within the program of said query and identifying the consumer terminal that issued said query; and
(c) a supplemental information identifier for identifying in said table said supplemental information link based on a time or frame location range associated with the interactivity point and the supplemental information location.

2. The system of claim 1 further comprising:
(a) a supplemental information database for maintaining said supplemental information; and
(b) a sender for transmitting said supplemental information link to said consumer terminal and for transmitting said supplemental information provided by said supplemental information database, using said supplemental information link.

3. The system of claim 1 further comprising:
an accounting unit for establishing a revenue value according to the usage of said supplemental information associated to said program.

4. The system of claim 1 further comprising:
an on-screen cue unit for inserting a video cue at said supplemental information location within said program for indicating availability of said supplemental information on said consumer terminal.

5. The system of claim 4 wherein said video cue further indicates specifics on the type of said supplemental information.

6. The system of claim 1 wherein said supplemental information link provides additional links to further supplemental information.

7. The system of claim 1 wherein said supplemental information location is a range of time defined in said table by the time elapsed in the program when the supplemental information becomes relevant and the time elapsed in the program after which the supplemental information is no longer relevant.

8. The system of claim 1 wherein said table further includes comments regarding said supplemental information for display on said consumer terminal together with said supplemental information link.

9. The system of claim 1 wherein said query processor includes a means for listening for queries transmitted by said consumer terminal, a means for identifying said consumer terminal that issued said query and a means for determining the interactivity point within the program of said query.

10. A method of associating supplemental information from a local server with a program distributed to consumer terminals comprising the steps of:
(a) maintaining a table with an association between a supplemental information location within said program where supplemental information is relevant and a supplemental information link;
(b) receiving a query from a consumer terminal and determining an interactivity point within the program of said query;
(c) identifying said consumer terminal that issued said query; and
(d) identifying in said table said supplemental information link based on a time or frame location range associated with the interactivity point and the supplemental information location.

11. The method of claim 10 further comprising the step of:
transmitting said supplemental information link to said consumer terminal for enabling access to said supplemental information provided by said supplemental information link.

12. The method of claim 10 further comprising the step of:
transmitting said supplemental information to said consumer terminal upon request.

13. The method of claim 10 further comprising the step of:
establishing a revenue value according to the usage of said supplemental information associated with said program.

14. The method of claim 10 further comprising the step of:
providing a video cue within said program for indicating availability of said supplemental information.

15. A system for associating supplemental information from a local server with a program distributed to consumer terminals, comprising at said local server:
(a) a table for maintaining an association between a supplemental information link and a supplemental information location within said program where the supplemental information link is relevant;
(b) a query processor for receiving a query from a consumer terminal and determining an interactivity point within the program of said query and identifying the consumer terminal that issued said query; and
(c) a supplemental information identifier for identifying in said table said supplemental information link based on the interactivity point and the supplemental information location.

16. A device for use in associating supplemental information from a local server with a program distributed to consumer terminals comprising:
(a) a listener for receiving a query from a consumer terminal;
(b) a location unit for determining an interactivity point within the program of the query; and
(c) a consumer terminal identifier for identifying the consumer terminal that issued the query.

17. A device for use in associating supplemental information from a local server with a program distributed to consumer terminals comprising:
an identifier that locates in a table a supplemental information link based on an interactivity point and a supplemental information location.

18. The device of claim 17 wherein the identifier is connected to a query processor for obtaining the interactivity point.
